(19) United States
(12) Patent Application Publication
(10) Pub. No.: US 2009/0121044 A1
(43) Pub. Date: May 14, 2009

(54) Water outlet having temperature sensor

(76) Inventors: Rober Lo, Taichung (TW); Kai Po Wang, Taichung (TW)

Correspondence Address: CHARLES E. BAXLEY, ESQUIRE, 90 JOHN STREET, SUITE 309, NEW YORK, NY, 10038, US

(21) Appl. No.: 11/983,309

(22) Filed: Nov. 8, 2007

(51) Int. Cl. B67D 5/06

(52) U.S. Cl. 239/71

(57) ABSTRACT

A water outlet device includes a housing member, a temperature detecting device having a receptacle attached to the outlet portion of the housing member, a sensor disposed in the receptacle for detecting a temperature of the water flowing through the receptacle, and an indicating device attached to the housing members and coupled to the sensor for indicating the water temperature and for preventing the users from being scaled by the hot water. One or more solar cells or an energizing device may be powered by water or manually and may be used for energizing the indicating device or the sensor without the typical batteries that will pollute our environment.

### BACKGROUND OF THE INVENTION

1. Field of the Invention

The present invention relates to a water outlet device, and more particularly to a water outlet device including a temperature detector or sensor for detecting or sensing the temperature of the water flowing out of the water outlet device and including a power device for generating an electricity by a flowing water or by the users themselves and including an indicating device for indicating the temperature of the water flowing out of the water outlet device and the temperature detecting device and for preventing the users from being scaled by hot water.

2. Description of the Prior Art

Typical water outlet devices, such as water faucets, shower nozzles, shower heads, or other nozzles comprise a nozzle body for coupling to the water reservoir and/or for being held or grasped by the users, and including a water outlet or opening for allowing the water to flow out through the water outlet or opening of the water outlet devices.

For example, U.S. Pat. No. 7,197,776 to Tsai discloses one of the typical shower nozzle holder devices comprising a shower nozzle coupled to the water reservoir with a hose or pipe and for being held or grasped by the users in order to conduct the showering operations.

However, the typical shower nozzles have no temperature detectors or sensors to detect or sense the temperature of the water flowing out of the typical shower nozzles, such that the users have to use their hands to test or to detect the temperature of the water, and such that the users may have a good chance to be scaled by the hot water inadvertently.

The present invention has arisen to mitigate and/or obviate the afore-described disadvantages of the conventional water outlet devices.

### SUMMARY OF THE INVENTION

The primary objective of the present invention is to provide a water outlet device including a temperature detector or sensor for detecting or sensing the temperature of the water flowing out of the water outlet device and for preventing the users from being scaled by the hot water.

The other objective of the present invention is to provide a water outlet device including a power device, such as one or more solar cells or an energizing device which may generate an electricity by a solar energy or which may be powered by the water flow or which may be powered manually and may be used for energizing the indicating device or the sensor without the typical batteries that will pollute our environment.

The further objective of the present invention is to provide a water outlet device including an indicating device for indicating the temperature of the water flowing out of the water outlet device and the temperature detecting device and for preventing the users from being scaled by hot water.

In accordance with one aspect of the invention, there is provided a water outlet device comprising a housing member having a water outlet portion, a temperature detecting device including a receptacle attached to the outlet portion of the housing member, a sensor disposed in the receptacle for detecting a temperature of the water flowing through the receptacle, an indicating device attached to the housing members and coupled to the sensor for indicating the water temperature and for preventing the users from being scaled by the hot water, and an energizing device powered by a solar energy or powered by the water flowing through the receptacle or powered manually by the users for generating an electricity and for energizing the indicating device or the sensor without the typical batteries that will pollute our environment.

The indicating device includes an indicating member for generating an indicating signal to show that the water is hot, and/or for generating an indicating signal to show that the water is cold, and/or for generating an indicating signal to show that the water temperature is comfortable.

The receptacle includes a casing provided or disposed in the receptacle for forming an inner peripheral space between the receptacle and the casing. The sensor is received in the inner peripheral space between the receptacle and the casing and partially extended into the casing.

The energizing device may include such as a water powered rotor disposed in the receptacle for being propelled and actuated by the water flowing through the receptacle, and an electric generator coupled to the rotor for being actuated by the rotor to generate an electricity to energize the indicating device or the sensor or the other electrical parts or elements.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a water outlet device in accordance with the present invention including a temperature detecting or sensing device for detecting or sensing the temperature of the water flowing out of the water outlet device;

FIG. 2 is a partial exploded view of the water outlet device;

FIG. 3 is a perspective view of the temperature detecting or sensing device for the water outlet device;

FIG. 4 is a plan schematic view illustrating the operation of the water outlet device;

FIG. 5 is a perspective view similar to FIG. 1, illustrating the other application of the water outlet device; and

FIG. 6 is a partial exploded view of the water outlet device as shown in FIG. 5.

### DETAILED DESCRIPTION OF THE PREFERRED EMBODIMENT

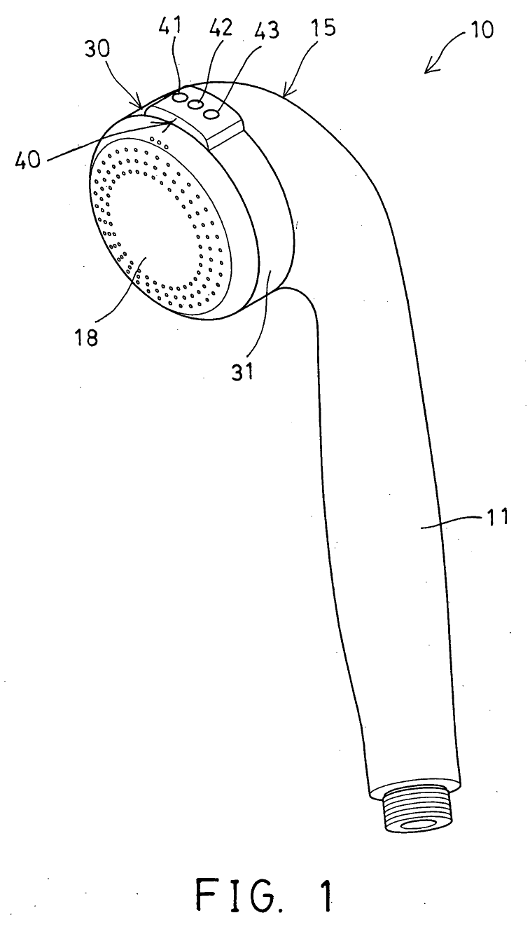

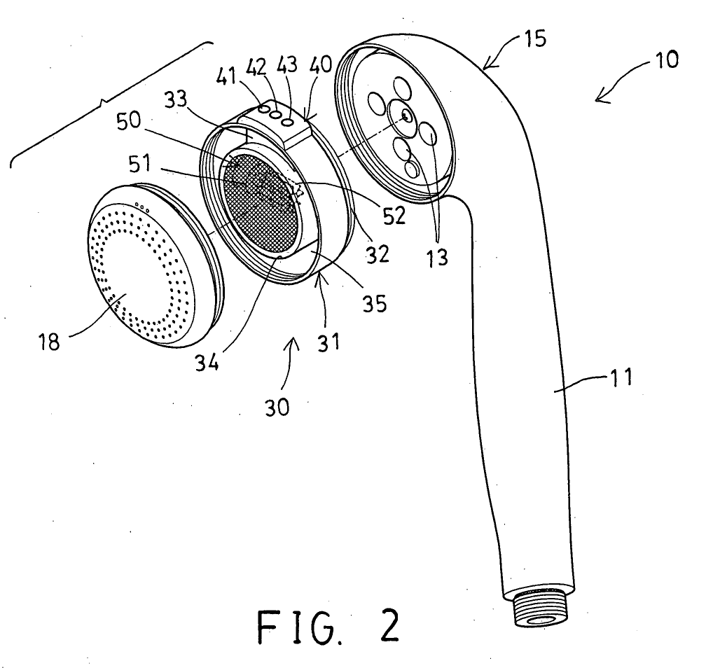

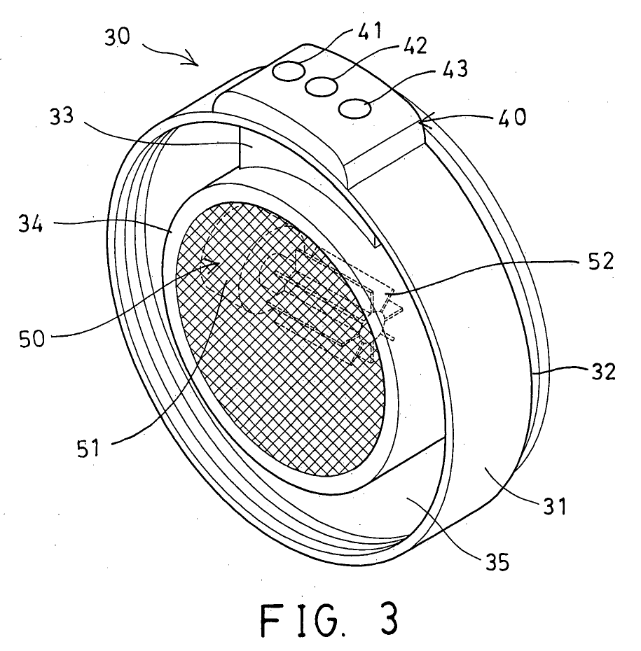

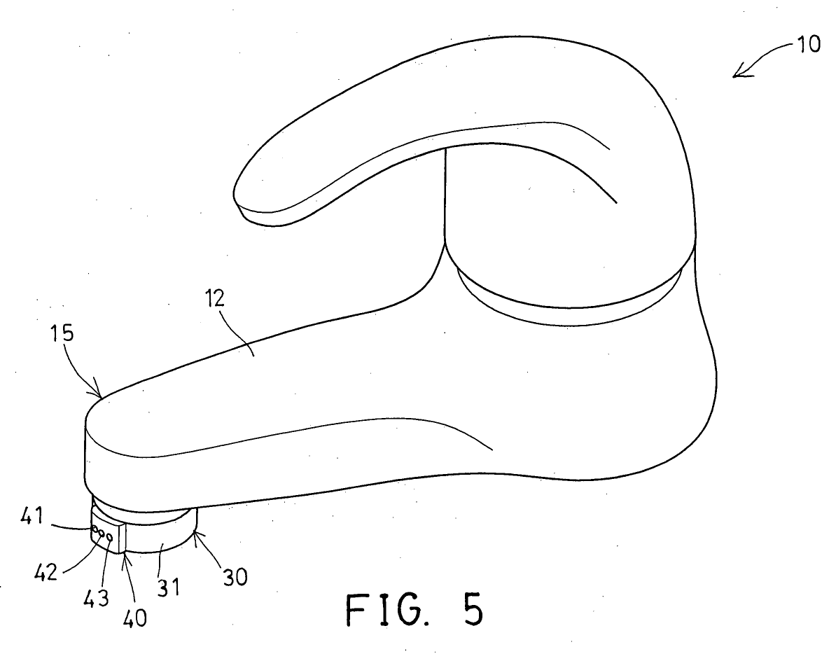

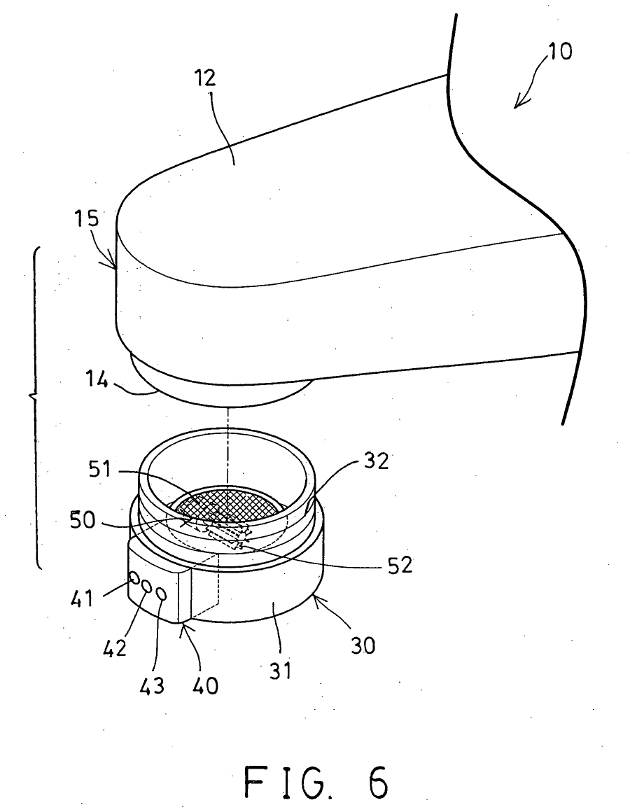

Referring to the drawings, and initially to FIGS. 1-3, a water outlet device 10 in accordance with the present invention comprises a water outlet body or housing member 11, such as a handle or housing member 11 of a shower nozzle (FIGS. 1, 2), a faucet body or housing member 12 of a typical water faucet (FIGS. 5-6) coupled to the water reservoir (not shown) for receiving the water from the water reservoir, and the housing member 11 includes one or more outlet openings 13 (FIG. 2), or 14 (FIG. 6) formed in the outlet portion 15 thereof for allowing the water to out of the housing member 11. The above-described structure is typical and will not be described in further details.

The water outlet device 10 in accordance with the present invention further comprises a temperature detecting or sensing device 30 attached to the outlet portion 15 of the housing member 11 for detecting or sensing the temperature of the water flowing out through the outlet openings 13 or 14 of the water outlet device 10. The temperature detecting device 30 includes a receptacle 31 detachably attached or secured to the outlet portion 15 of the housing member 11 with fasteners or latches (not shown), or an attaching or securing means or device 32, such as a threading engagement 32 for allowing the housing member 11 to be selectively and detachably attached or secured to the housing members 11 of various water outlet devices 10.

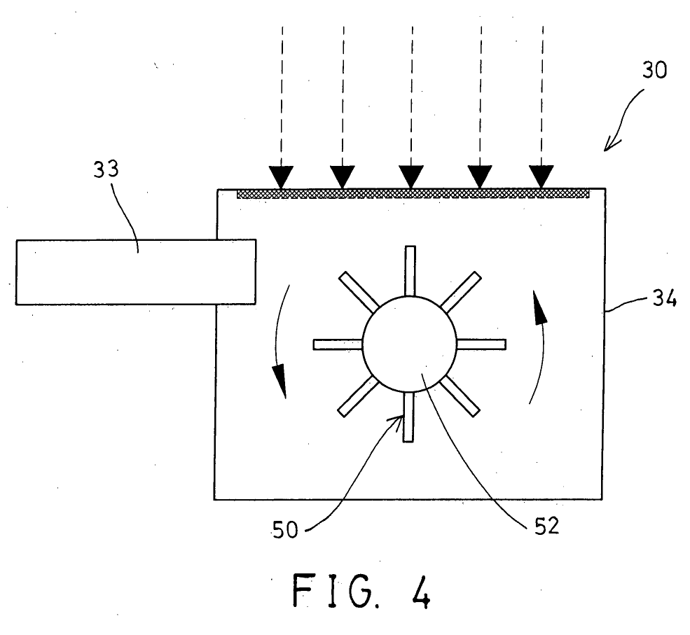

The temperature detecting device 30 includes a detector or sensor 33 disposed in the receptacle 31 for detecting or sensing the temperature of the water flowing through the receptacle 31 of the temperature detecting device 30. For example, the receptacle 31 includes a casing 34 extended or provided in the inner portion of the receptacle 31 for forming or defining an inner peripheral space 35 between the receptacle 31 and the casing 34 and for receiving the detector or sensor 33 which may be partially extended into the casing 34 (FIG. 4) and which may be used to detect or to sense the temperature of the water flowing through the casing 34 and/or the receptacle 31.

The temperature detecting device 30 further includes an indicating device 40 attached or secured to the outer peripheral portion of the housing members 11 and having one or more (such as three) indicating members 41, 42, 43, such as buzzers or light members 41, 42, 43 electrically coupled to the detector or sensor 33 directly, or indirectly via a control or processing device (not shown) for indicating the temperature of the water flowing out of the water outlet device 10 and the temperature detecting device 30 and for preventing the users from being scaled by hot water. A cover 18 may be attached to the receptacle 31 for shielding or covering the detector or sensor 33.

In operation, as shown in FIG. 4, the temperature of the water flowing through the casing 34 and/or the receptacle 31 may be detected or sensed by the detector or sensor 33 of the temperature detecting device 30, and either of the indicating members 41, 42, 43 may be actuated or used to generate a warning or indicating signal. For example, one of the indicating members 41 may generate an indicating signal to show that the temperature of the water is cold or below a predetermined comfortable temperature, the other indicating member 43 may generate an indicating signal to show that the temperature of the water is hot or higher than a predetermined comfortable temperature, and the further indicating member 42 may generate an indicating signal to show that the temperature of the water is a comfortable temperature for showing purposes.

The temperature detecting device 30 further includes a power source or energizing means or power device 50 electrically coupled to the indicating device 40 and the detector or sensor 33 of the temperature detecting device 30 for energizing the indicating device 40 and the detector or sensor 33 or the other electrical parts or elements, and it is preferable that the power source or energizing means or power device 50 may include such as one or more solar cells that may be powered or operated by the solar energy that will not pollute our environment, or may be powered or operated by an electric generator 51 that may be propelled or actuated by the water flowing through the casing 34 and/or the receptacle 31 or actuated or operated by the users manually, without using the typical batteries that will pollute our environment.

For example, as shown in FIGS. 2-4, the power source or energizing means or power device 50 may include the electric generator 51, and a rotor 52 coupled to the electric generator 51 and disposed in the casing 34 or the receptacle 31 and arranged for being propelled or actuated by the water flowing through the casing 34 and/or the receptacle 31 or actuated or operated by the users manually, and the electric generator 51 may be caused to generate an electricity when the rotor 52 is propelled or actuated by the water or operated by the users manually, in order to energize the indicating device 40 and the detector or sensor 33 or the other electrical parts or elements.

It is to be noted that one of the indicating members 41 may show that the temperature of the water is cold or below a predetermined comfortable temperature, the other indicating member 43 may show that the temperature of the water is hot or higher than a predetermined comfortable temperature, and the other indicating member 42 may show that the temperature of the water is a comfortable temperature for showing purposes, such that the users may easily know the temperature of the water and need not to test or to detect the temperature of the water with their hands and such that the users may be prevented from being scaled by the hot water. It is preferable that the attaching or securing means or device 32 may be used to detachably attach or secure the receptacle 31 to the outlet portion 15 of the housing member 11 of various water outlet devices 10.

Accordingly, the water outlet device in accordance with the present invention includes a temperature detector or sensor for detecting or sensing the temperature of the water flowing out of the water outlet device and for preventing the users from being scaled by the hot water, and an energizing device powered by a solar energy or powered by the water flowing through the receptacle or powered manually by the users for generating an electricity and for energizing the indicating device or the sensor without the typical batteries that will pollute our environment.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A water outlet device comprising:
a housing member having a water outlet portion,
a temperature detecting device including a receptacle attached to said outlet portion of said housing member,
a sensor disposed in said receptacle for detecting a temperature of the water flowing through said receptacle,
an indicating device attached to the housing members and coupled to the sensor for indicating the water temperature, and
a power device coupled to said indicating device and said temperature detecting device for energizing said indicating device and said temperature detecting device.

2. The water outlet device as claimed in claim 1, wherein said indicating device includes an indicating member for generating an indicating signal to show that the water is hot.

3. The water outlet device as claimed in claim 1, wherein said indicating device includes an indicating member for generating an indicating signal to show that the water is cold.

4. The water outlet device as claimed in claim 1, wherein said indicating device includes an indicating member for generating an indicating signal to show that the water temperature is comfortable.

5. The water outlet device as claimed in claim 1, wherein said receptacle includes a casing provided in said receptacle for forming an inner peripheral space between said receptacle and said casing.

6. The water outlet device as claimed in claim 5, wherein said sensor is received in said inner peripheral space between said receptacle and said casing and partially extended into said casing.

7. The water outlet device as claimed in claim 1, wherein said power device includes a rotor disposed in said receptacle for being propelled and actuated by the water flowing through said receptacle.

8. The water outlet device as claimed in claim 7, wherein said power device includes an electric generator coupled to said rotor for being actuated by said rotor.
